(19) United States
(12) Patent Application Publication
(10) Pub. No.: US 2019/0199795 A1
(43) Pub. Date: Jun. 27, 2019

(54) METHOD AND DEVICE FOR SYNCHRONIZING BACKUP DATA, STORAGE MEDIUM, ELECTRONIC DEVICE, AND SERVER

(71) Applicant: GUANGDONG OPPO MOBILE TELECOMMUNICATIONS CORP., LTD., Dongguan (CN)

(72) Inventor: Hui HE, Dongguan (CN)

(21) Appl. No.: 16/290,579

(22) Filed: Mar. 1, 2019

Related U.S. Application Data
(63) Continuation of application No. PCT/CN2017/095696, filed on Aug. 2, 2017.

(30) Foreign Application Priority Data
Oct. 25, 2016 (CN) 201610942150.3

(51) Int. Cl. H04L 29/08

(52) U.S. Cl. CPC H04L 67/1095; H04L 67/1097

(57) ABSTRACT

A method for synchronizing backup data, a device for synchronizing backup data, a storage medium, an electronic device, and a server are provided. The method includes the following operations. After logining to a target backup account, an adding instruction for a share account is received. A shared account is acquired based on the adding instruction. The shared account is added for the target backup account. A setting request for the shared account carrying the target backup account and the shared account is sent to a cloud server, such that the cloud server synchronizes the backup data based on the setting request.

This application is a continuation application of International Application No. PCT/CN2017/095696, filed on Aug. 2, 2017, which claims priority to Chinese Patent Application No. 201610942150.3, filed on Oct. 25, 2016, the entire disclosures of which are incorporated herein by reference.

### TECHNICAL FIELD

The present disclosure relates to a field of cloud backup technologies, and more particularly, to a method and a device for synchronizing backup data, a storage medium, an electronic device, and a server.

### BACKGROUND

The cloud backup is a newly-developing service of cloud computing. Cloud backup service providers bring together massive and heterogeneous storage devices in the network through technologies such as virtualization, distributed processing, and broadband network, to jointly provide data storage and backup services. Users may store intensively and manage safely massive and scattered files or folders on one or more terminals by accessing to the broadband Internet through the mobile Internet.

As people's requirements on cloud backup data synchronization increase, an importance of cloud backup data synchronization in the cloud backup also becomes higher. The cloud backup data synchronization is to back up data in a certain terminal to a cloud server, and to send the backup data to other one or more terminals through the cloud server, thereby synchronizing data among the terminals.

### SUMMARY

As a first aspect, embodiments of the present disclosure provide a method for synchronizing backup data. The method includes the following operations.

It logins to a target backup account.

An adding instruction for a shared account is received.

The shared account is acquired based on the adding instruction.

The shared account is added for the target backup account.

A setting request for the shared account is sent to a cloud server, the setting request carrying the target backup account and the shared account.

As a second aspect, embodiments of the present disclosure also provide another method for synchronizing backup data. The method includes the following operations.

A setting request for a shared account from a first terminal is received. The setting request carries a target backup account, and a shared account for the target backup account.

A shared backup area of the shared account is created based on the setting request.

Target shared data in a private backup area of the target backup account is added to the shared backup area.

A data synchronization request from a second terminal and carrying the shared account is received, and the target shared data in the shared backup area is synchronized to the second terminal in response to the data synchronization request.

As a third aspect, embodiments of the present disclosure provide an electronic device. The electronic device includes a processor and a memory. The memory is configured to store a plurality of instructions. The processor is configured to load the plurality of instructions in the memory to perform the method for synchronizing backup data provided in any embodiment of the present disclosure.

### BRIEF DESCRIPTION OF THE DRAWINGS

To more clearly illustrate the technical solutions in the embodiments of the present disclosure, the drawings used in the description of the embodiments will be briefly described below. It is obvious that the drawings in the following description are only some embodiments of the present disclosure. Other drawings may also be obtained from those skilled in the art based on these drawings without paying any creative effort.

FIG. 1 is a first flow chart illustrating a method for synchronizing backup data according to an embodiment of the present disclosure.

FIG. 2 is a schematic diagram illustrating a login page according to an embodiment of the present disclosure.

FIG. 3 is a schematic diagram illustrating a backup page according to an embodiment of the present disclosure.

FIG. 4 is a schematic diagram illustrating a shared account setting interface according to an embodiment of the present disclosure.

FIG. 5 is a second flow chart illustrating a method for synchronizing backup data according to an embodiment of the present disclosure.

FIG. 6 is a first block diagram illustrating a system for synchronizing backup data according to an embodiment of the present disclosure.

FIG. 7 is a third flow chart illustrating a method for synchronizing backup data according to an embodiment of the present disclosure.

FIG. 8 is a third block diagram illustrating a device for synchronizing backup data according to an embodiment of the present disclosure.

FIG. 9 is a fourth block diagram illustrating a device for synchronizing backup data according to an embodiment of the present disclosure.

FIG. 10 is a fifth block diagram illustrating a device for synchronizing backup data according to an embodiment of the present disclosure.

FIG. 11 is a sixth block diagram illustrating a device for synchronizing backup data according to an embodiment of the present disclosure.

FIG. 12 is a seventh block diagram illustrating a device for synchronizing backup data according to an embodiment of the present disclosure.

FIG. 13 is an eighth block diagram illustrating a device for synchronizing backup data according to an embodiment of the present disclosure.

FIG. 14 is a block diagram illustrating a server according to an embodiment of the present disclosure.

FIG. 15 is a block diagram illustrating an electronic device according to an embodiment of the present disclosure.

### EMBODIMENTS OF THE PRESENT DISCLOSURE

The technical solutions in the embodiments of the present disclosure are clearly and completely described in the following with reference to the drawings in the embodiments of the present disclosure. The embodiments described are only a part of the embodiments of the present disclosure, but not all embodiments. All other embodiments obtained by those skilled in the art based on the embodiments of the present disclosure without creative efforts are within the scope of the present disclosure.

The embodiments of the present disclosure provide a method for synchronizing backup data. The method includes the following operations.

After logining to a target backup account, an adding instruction for a shared account is received.

A shared account to be added is acquired based on the adding instruction.

The shared account is added for the target backup account.

A setting request for the shared account is sent to a cloud server, the setting request carrying the target backup account and the shared account, such that the cloud server synchronizes the backup data based on the setting request.

In an embodiment, after the receiving the adding instruction, and before the acquiring the shared account to be added, the method further includes the following operations.

Authentication information input by a user and of the target backup account is acquired.

The authentication information input by the user is verified.

The acquiring the shared account to be added based on the adding instruction is performed when the verification is passed.

In an embodiment, the setting request further carries at least one of: authentication information, shared time information, attribute information, and an operation authority. After the adding the shared account for the target backup account, and before the sending the setting request to the cloud server, the method further includes at least one of the following operations.

Authentication information of the shared account is set.

Shared time information of the shared account is set.

Attribute information of data to be shared corresponding to the shared account is set.

An operation authority of the shared account is set.

In an embodiment, it will be described from the perspective of a device for synchronizing backup data. The device may be integrated into a terminal or other device that needs the backup data synchronization. The terminal may be a mobile phone, a tablet computer, or the like.

The manner of integrating the device into the terminal may be various. For example, the device may be installed in the terminal in the form of terminal application.

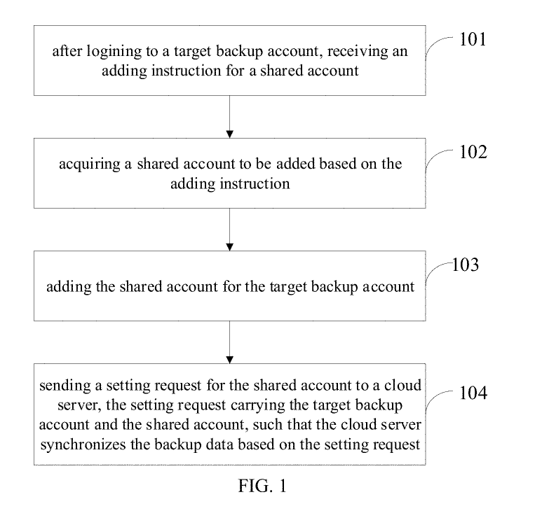

As illustrated in FIG. 1, a method for synchronizing backup data has the following flow.

At block 101, after logining to a target backup account, an adding instruction for a shared account is received.

Before the operation at block 101, the method in the present embodiment may further include a process of logining to the target backup account, as follows.

An account login request is sent to the cloud server. The account login request carries the target backup account and authentication information of the target backup account.

A login response message returned by the cloud server based on the account login request is received, and it logins to the target backup account based on the login response message.

In detail, the backup account and the authentication information of the backup account may be acquired, and the account login request is sent to the cloud server based on the target backup account and the authentication information of the target backup account.

The manner of acquiring the backup account and authentication information may be various. For example, the backup account and authentication information may be input by the user, i.e., the backup account and authentication information input by the user may be acquired, or, the backup account and authentication information may be automatically acquired, such as the backup account and authentication information may be automatically acquired from a local storage of the terminal or from the server.

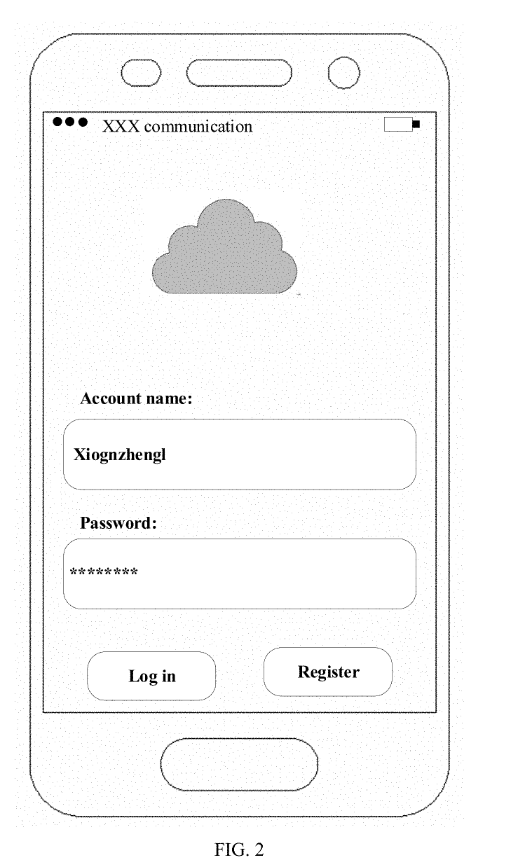

As illustrated in FIG. 2, a cloud backup application may provide a login page. The login page may include an account input interface, an authentication information input interface, and a login interface. The cloud backup application may acquire the target backup account input by the user through the account input interface. The cloud backup application may acquire the authentication information input by the user through the authentication information input interface. When receiving a login instruction triggered by the user through the login interface, the cloud backup application may send the account login request to the cloud server based on the login instruction, the target backup account, and the authentication information.

The representation of interfaces may be various, such as input boxes, icons. The specific representation may be set based on actual needs.

The login response message may include a first message for indicating that logining to the target backup account is allowed, or a second message for indicating that logining to the target backup account is denied. For example, when the cloud server fails to verify the authentication information, the second message is sent; and when the cloud server verifies the authentication information successfully, the first message is sent.

The operation of “logining to the target backup account based on the login response message” may include the following operations. When the login response message includes the first message, it logins to the target backup account.

In the present embodiment, the adding instruction may be triggered by an operation of the user, or may be triggered by the system.

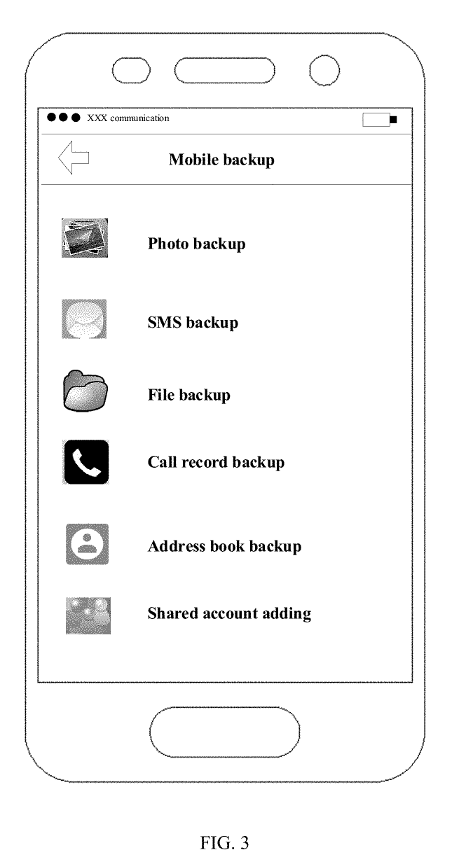

For example, in the actual application, the adding instruction may be triggered through an interface. As illustrated in FIG. 3, the cloud backup application may provide a shared account adding interface in a main backup page. The user may add the shared account through the account adding interface. That is, the operation of “receiving the adding instruction” may include the following operations. The adding instruction triggered by the user through the shared account adding interface is received. The shared account adding interface may have various forms, such as an input box and an icon button.

At block 102, a shared account to be added is acquired based on the adding instruction.

In the present embodiment, the manner of acquiring the shared account may be various. For example, the shared account may be input by the user or randomly generated. In detail, the shared account may be automatically acquired based on the adding instruction, or, the cloud backup application may provide a shared account adding page after receiving the account adding instruction, and the shared account adding page has a shared account input interface, and the user may input the shared account to be added through the shared account input interface. That is, the operation of “acquiring the shared account to be added based on the adding instruction” may include the following operations.

A shared account adding page is generated. The shared account adding page includes a shared account input interface.

The shared account input by the user is acquired through the shared account input interface.

In an embodiment, in order to improve the security of the backup account and the backup data, the verification of authentication information such as a password may be performed before the shared account is added. If the verification is passed, the shared account is added. That is, after the receiving the adding instruction, and before the acquiring the shared account to be added, the method further includes the following operations.

Authentication information input by a user and corresponding to the target backup account is acquired.

The authentication information input by the user is verified.

When the verification is passed, the acquiring the shared account to be added based on the adding instruction is performed.

In detail, the manner of verifying the authentication information input by the user may be various. For example, a verification request may be sent to the cloud server. The verification request carries the target backup account and the authentication information input by the user. A verification result returned by the cloud server based on the verification request is received. When the verification result is success, the operation of adding the shared account for the target backup account is performed, such as it jumps to the shared account addition page.

At block 103, the shared account is added for the target backup account.

In detail, the shared account may be bound to the target backup account.

At block 104, a setting request for the shared account is sent to a cloud server, the setting request carrying the target backup account and the shared account, such that the cloud server synchronizes the backup data based on the setting request.

For example, a sending instruction of setting the account may be received. The setting request carrying the target backup account and the shared account may be generated based on the instruction. The setting request may be sent to the cloud server. In an embodiment, in order to improve the security of the shared account and the shared data, the method in the embodiment may further include at least one of the following operations between the operations at blocks 103 and 104.

(1) Authentication information of the shared account is set.

The setting request may also carry the authentication information. The authentication information may be information such as a password or a biometric. It may improve the security of the shared account and the shared data by setting the authentication information.

In detail, an authentication setting instruction may be received. The authentication information of the shared account is set based on the authentication setting instruction. For example, the authentication information input by the user is acquired based on the authentication setting instruction, and the authentication information input by the user is regarded as the authentication information of the shared account.

In the embodiment, the manner of setting information (authentication information, shared information, attribute information, and operation authority) corresponding to the shared account may be various. In order to facilitate the user to set the authentication information and improve the user experience, the embodiment may provide a shared account settings page, and a corresponding setting interface may be set on the page. Therefore, the user may set the shared account through the setting interface.

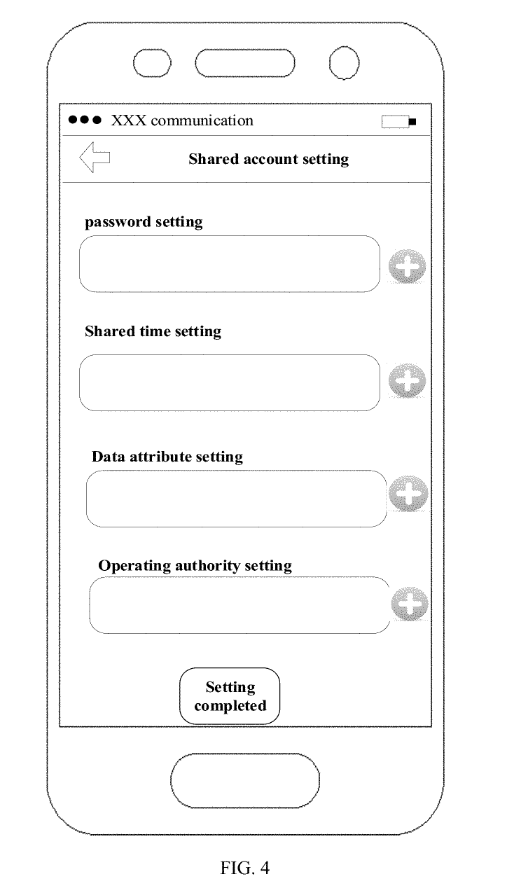

As illustrated in FIG. 4, the shared account settings page may include: an authentication setting interface (i.e., “password setting” in FIG. 4). The authentication setting information input by the user through the authentication setting interface may be received, and the authentication information of the shared account is set based on this authentication setting information. For example, the input authentication information is regarded as the authentication information of the shared account.

(2) Shared time information of the shared account is set.

The setting request may also carry the shared time information. It may improve the security of the shared data and save a storage space of the cloud server by setting the shared time information.

In detail, a shared time setting instruction may be received. The shared time information of the shared account may be set based on the shared time setting instruction.

For example, time information input by the user may be received based on the shared time setting instruction, or, time information selected by the user may be acquired. The shared time information may be set based on the time information input by the user or the time information selected by the user.

As illustrated in FIG. 4, the shared account settings page may include: a time setting interface (i.e., “shared time setting” in FIG. 4). A time setting instruction triggered by the user through the time setting interface may be received. Time setting information input by the user may be acquired based on the time setting instruction. The shared time information of the shared account may be set based on the time setting information. For example, the input time information may be set as the shared time information of the shared account.

(3) Attribute information of data to be shared corresponding to the shared account is set.

The setting request may also carry the attribute information of data to be shared. It may improve the speed and accuracy of sharing data by setting the attribute information.

In detail, an attribute setting instruction may be received. The attribute information of the data to be shared corresponding to the shared account may be set based on the attribute setting instruction. For example, a plurality of candidate attribute information may be acquired based on the attribute setting instruction. Target attribute information is selected from the plurality of candidate attribute information. The target attribute information is set as the attribute information of the data to be shared corresponding to the shared account. For another example, the target attribute information input by the user is acquired based on the attribute setting instruction, and the attribute information of the data to be shared corresponding to the shared account is set based on the target attribute information.

As illustrated in FIG. 4, the shared account settings page may include: an attribute setting interface (i.e., “data attribute setting” in FIG. 4). An attribute setting instruction triggered by the user through the attribute setting interface may be received. An attribute list may be provided based on the attribute setting instruction. A selecting instruction input by the user for the attribute list is received. Target attribute information is selected from the attribute list based on the selecting instruction. The target attribute information is set as the attribute information of the data to be shared corresponding to the shared account. The attribute information may include a data type, a data identifier, and the like.

(4) An operation authority of the shared account is set.

The setting request may also carry the operation authority. It may ensure the accuracy and consistency of data synchronization.

In detail, an operation authority setting instruction may be received. Operation authority setting information may be acquired based on the operation authority setting instruction. The operation authority of the shared account is set based on the operation authority setting information.

For example, a plurality of candidate operation items may be acquired based on the operation authority setting instruction. A target operation item is selected from the plurality of candidate operation items. That is, the operation authority of the shared account on this operation item is set. The operation item corresponding to the shared account is set based on the target operation item. The candidate operation items may include: a download item, an upload item, a data synchronization item, a data change item, and the like.

As illustrated in FIG. 4, the shared account settings page may include: an operation authority setting interface. An operation authority setting instruction triggered by the user through the operation authority setting interface may be received. An operation list (including a plurality of candidate operation items) is provided based on the operation authority setting instruction. Selecting information of the user for the operation list may be received. A target operation item is acquired from the operation list based on the selecting information. The operation item corresponding to the shared account is set based on the target operation item.

The above operations in (1)-(4) may be combined arbitrarily. The shared account settings page may provide a setting interface of the operation, and the setting request may also carry corresponding information.

As illustrated in FIG. 4, in the embodiment, the shared account settings page is further provided with a setting sending interface. After the user sets the information for the shared account, a setting sending instruction may be triggered through the setting sending interface “setting completed”. The terminal may generate the setting request carrying the target backup account, the shared account, (at least one of the authentication information, shared time information, attribute information, and operation authority) based on the setting sending interface. The terminal may send the request to the cloud server.

It may be seen that, in the embodiments of the present disclosure, after logining to the target backup account, the adding instruction is received; the shared account to be added is acquired based on the adding instruction; the shared account is added for the target backup account; and the setting request carrying the target backup account and the shared account is set to the cloud server, such that the cloud server synchronizes the backup data based on the setting request. The solution may synchronize the backup data based on the shared account associated with the backup account and the shared backup area of the shared account. When the backup data is synchronized based on the shared account, other synchronous terminals may acquire the backup data in the shared backup area only, and cannot acquire the backup data in the private backup area of the backup account, thereby preventing the backup data from leaking. Therefore, compared with the related art, it may improve the security of the backup data. The embodiments of the present disclosure further provide another method for synchronizing backup data. The method includes the following operations.

A setting request for a shared account from a first terminal is received. The setting request carries a target backup account, and a shared account for the target backup account.

A shared backup area of the shared account is created based on the setting request.

Target shared data in a private backup area of the target backup account is added to the shared backup area.

A data synchronization request from a second terminal and carrying the shared account is received. The target shared data in the shared backup area is synchronized to the second terminal in response to the data synchronization request.

In an embodiment, the setting request further carries attribute information of data to be shared corresponding to the shared account.

The adding the target shared data in the private backup area of the target backup account to the shared backup area includes the following operations.

Based on the attribute information, the target shared data in the private backup area of the target backup account is determined.

The target shared data is copied into the shared backup area.

In an embodiment, the setting request further carries first authentication information of the shared account. The data synchronization request further carries second authentication information of the shared account.

After the receiving the data synchronization request, and before the synchronizing the target shared data in the shared backup area to the second terminal in response to the data synchronization request, the method further includes the following operations.

The second authentication information is matched with the first authentication information.

The synchronizing the target shared data in the shared backup area to the second terminal in response to the data synchronization request, is performed when the matching is successful.

In an embodiment, the setting request further carries shared time information of the shared account. After the receiving the setting request, the method further includes the following operations.

The target shared data in the shared backup area is deleted based on current system time information and the shared time information.

In an embodiment, the setting request further carries an operation authority of the shared account. After the receiving the data synchronization request, and before the synchronizing the target shared data in the shared backup area to the second terminal in response to the data synchronization request, the method further includes the following operations.

It is determined whether an operation corresponding to the data synchronization request satisfies the operation authority.

When the operation corresponding to the data synchronization request satisfies the operation authority, the synchronizing the target shared data in the shared backup area to the second terminal in response to the data synchronization request is performed.

In an embodiment, it will be described from the perspective of another device for synchronizing backup data. The device may be integrated in a server or other device that needs to synchronize the backup data. The server may be a cloud server or the like.

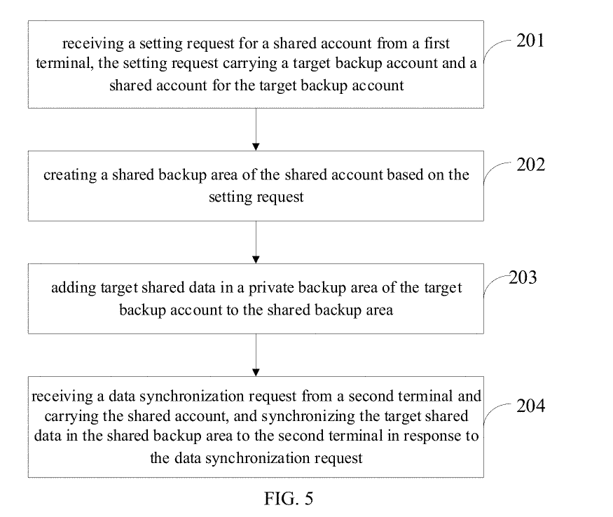

As illustrated in FIG. 5, a method for synchronizing backup data has the following flow.

At block 201, a setting request for a shared account from a first terminal is received. The setting request carries a target backup account, and a shared account for the target backup account.

For example, after the first terminal logins to the target backup account, the setting request from the first terminal may be received.

The target backup account may be a cloud backup account. The terminal may login to the backup account to perform operations such as uploading or downloading backup data. The shared account is an associated account of the target backup account. The shared account is configured to share the backup data. In some embodiments, the shared account may be as a subordinate account or a sub account of the target backup account.

At block 202, a shared backup area of the shared account is created based on the setting request.

In an embodiment, the manner of creating the shared backup area may be various. For example, a storage area may be designated as the shared backup area. That is, the operation of creating the shared backup area of the shared account based on the setting request may include the following operations.

A storage area is allocated based on the setting request.

The storage area is specified as the shared backup area of the shared account.

In detail, the storage area may be allocated from the backup storage area corresponding to the target backup account based on the setting request. For example, an empty storage area may be allocated from the backup storage area corresponding to the target backup account.

At block 203, target shared data in a private backup area of the target backup account is added to the shared backup area.

In detail, the target shared data that needs to be shared may be determined from the private backup area of the target backup account. The target shared data may be added to the shared backup area.

The manner of adding the target shared data to the shared backup area may be various. The target shared data may be transferred to the shared backup area, or, the target shared data may be copied to the shared backup area. The adding manner may be set based on actual needs.

In an embodiment, the manner of determining the target shared data to be shared may be also various. For example, the unencrypted backup data in the private backup area may be determined as the target shared data. That is, the operation of adding the target shared data in the private backup area of the target backup account to the shared backup area may include the following operations.

Unencrypted backup data in the private backup area of the target backup account may be determined.

The unencrypted backup data is added to the shared backup area.

For example, the backup data that needs to be shared may be set by the user. For example, the user may select the data to be shared on the terminal after adding the shared account. After the user selects, the attribute information such as the identifier of the shared data selected by the user may be sent to the cloud server, such that the cloud server determines the target shared data. That is, the operation of adding the target shared data in the private backup area of the target backup account to the shared backup area may include the following operations.

Target shared data in the private backup area of the target backup account is determined based on the attribute information.

The target shared data is copied to the shared backup area.

The attribute information of the data may include information such as an identifier of the data, a type of the data, and the like. For example, when the attribute information includes the type of the target data, the operation of determining the target shared data in the private backup area of the target backup account based on the attribute information may include the following operations.

A type of the backup data in the private backup area of the target backup account is acquired.

The corresponding target shared data is determined in the private backup area based on the type of the backup data and the type of the target data.

In an embodiment, the private backup area of the target backup account and the shared backup area of the shared account may be two storage areas or units that are isolated and independent from each other, for example, they may be on different storage media.

At block 204, a data synchronization request from a second terminal and carrying the shared account is received, and the target shared data in the shared backup area is synchronized to the second terminal in response to the data synchronization request.

In the embodiment, the second terminal and the first terminal are different. For example, they are different terminals of the same user, or terminals of different users, and the like.

The operation of synchronizing the target shared data in the shared backup area to the second terminal in response to the data synchronization request may include the following operations. The target shared data in the shared backup area is sent to the second terminal in response to the data synchronization request.

In detail, in order to improve the flexibility of the data synchronization, in the embodiment, the attribute information of the data in the shared backup area, such as the identifier, is sent to the second terminal in response to the data synchronization request, such that the second terminal may select. The selecting information returned by the second terminal may be received. The target backup data may be sent to the second terminal based on the selecting information, to realize the data synchronization. That is, the operation of synchronizing the target shared data in the shared backup area to the second terminal in response to the data synchronization request may include the following operations.

The attribute information of the shared data in the shared backup area is sent to the second terminal in response to the data synchronization request.

Selecting synchronization information returned by the second terminal is received.

Corresponding target shared data in the shared backup area is sent to the second terminal based on the selecting synchronization information.

For example, after receiving the data synchronization request, the cloud server may send identifiers of all the shared data in the shared backup area to the second terminal (which may be in the form of a list). The second terminal may select the corresponding target identifier from the identifiers and return it to the cloud server. The cloud server may send corresponding target shared data in the shared backup area to the second terminal based on the target identifier, to realize data synchronization.

In an embodiment, in order to improve data and account security, authentication information such as a password may be set for the shared account, such that other terminals need to input or send correct authentication information when data synchronization is required, thereby ensuring the data security. That is, the setting request may further carry the first authentication information of the shared account, and the data synchronization request may further carry the second authentication information of the shared account.

After the receiving the data synchronization request, and before the synchronizing the target shared data in the shared backup area to the second terminal in response to the data synchronization request, the method further includes the following operations.

The second authentication information is matched with the first authentication information.

When the matching is successful, the synchronizing the target shared data in the shared backup area to the second terminal in response to the data synchronization request is performed.

The authentication information may include: a password, biometric information (fingerprint, iris, etc.) and the like.

For example, after receiving the first authentication information of the shared account, the cloud server may save the first authentication information. After receiving the data synchronization request, the cloud server may extract the first authentication information from the storage. The cloud server, based on the first authentication information, verifies the second authentication information carried in the request (i.e., the matching process described above). When the verification passes, the data synchronization is performed; otherwise, the data synchronization is not performed.

In an embodiment, in order to improve the data security and save the storage space, the target shared data in the shared backup area may be deleted under a certain time condition. In detail, the setting request also carries shared time information of the shared account. After receiving the setting request, the method in the embodiment may further include the following operation. The target shared data in the shared backup area is deleted based on current system time information and the shared time information.

The shared time information may include a shared period, i.e., an effective time period of sharing the data. The operation of deleting the target shared data in the shared backup area based on the current system time information and the shared time information may include the following operations.

It is determined whether the current system time reaches the sharing period. When the current system time reaches the sharing period, the target shared data in the shared backup area is deleted.

The shared time information may be set by the user of the first terminal based on actual needs. For example, the shared period may be set to 2016-9-5. If the system time reaches 2016-9-5, the target shared data in the shared backup area may be deleted, thereby reducing the stolen risk caused by the long-term existence of the shared data, and saving storage space.

In an embodiment, in order to improve the accuracy and consistency of synchronizing data, operations of the synchronization user on the shared account may be limited, thereby preventing the synchronization user from modifying the shared data under the shared account, and thus ensuring the accuracy and consistency of synchronizing data. In detail, the setting request further carries an operation authority. After the receiving the data synchronization request, and before the synchronizing the target shared data in the shared backup area to the second terminal in response to the data synchronization request, the method may further include the following operation.

It is determined whether an operation corresponding to the data synchronization request satisfies the operation authority.

When the operation corresponding to the data synchronization request satisfies the operation authority, the synchronizing the target shared data in the shared backup area to the second terminal in response to the data synchronization request is performed.

The operation authority may be an authority of operation of the terminal (other than the terminal that sets the shared account) on the shared account. In detail, it may be the operation authority of other terminals on the shared data of the shared backup area under the shared account. The operation authority may include a plurality of operation items (such as an operation item list) that may be allowed to be executed. The operation item may include at least one of: a synchronization operation, an upload operation, a data modification operation, and the like. The operation authority may be set based on actual needs of the user.

When the operation authority includes the operation item list, the operation of determining whether the operation corresponding to the data synchronization request satisfies the operation authority may include the following operation. It is determined whether the operation corresponding to the data synchronization request is in the operation item list. When the operation corresponding to the data synchronization request is in the operation item list, the operation corresponding to the data synchronization request satisfies the operation authority; otherwise, the operation corresponding to the data synchronization request does not satisfy the operation authority.

It may be seen that, in the embodiments of the present disclosure, after the setting request from the first terminal is received, the shared backup area of the shared account is created based on the setting request; the target shared data in the private backup area of the target backup account is added to the shared backup area; the data synchronization request from the second terminal and carrying the shared account is received, and the target shared data in the shared backup area is synchronized to the second terminal in response to the data synchronization request. The solution may synchronize the backup data based on the shared account associated with the backup account and the shared backup area of the shared account. When the backup data is synchronized based on the shared account, other synchronous terminals may acquire the backup data in the shared backup area only, and cannot acquire the backup data in the private backup area of the backup account, thereby preventing the backup data from leaking. Therefore, compared with the related art, it may improve the security of the backup data.

In an embodiment, it will be further described on the basis of the method described in the above embodiments.

An example for detailed description is that the device in the foregoing embodiments is integrated in the terminal, and another device in the foregoing embodiments is integrated in the server. The server may be a cloud server for backup, and the terminal may be a mobile phone, a tablet, a laptop, and the like.

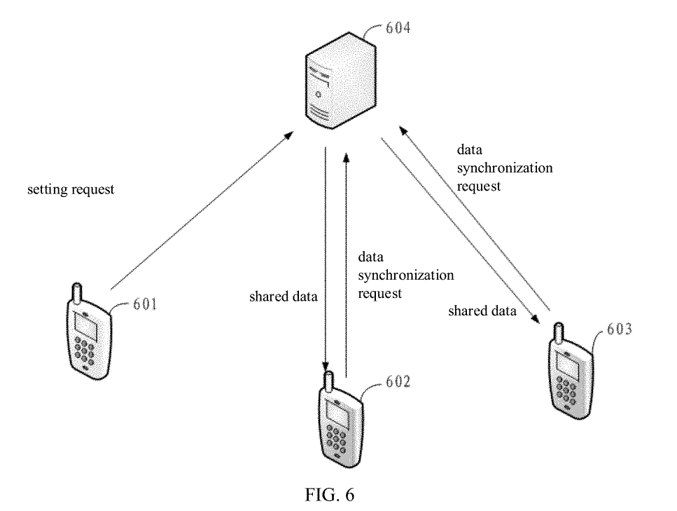

As illustrated in FIG. 6, a system for synchronizing backup data is provided. The system includes a terminal 601, a terminal 602, a terminal 603, and a server 604. In the system, the terminal and server 604 are coupled via a network such as a wireless network. In other embodiments, the system may also include more terminals.

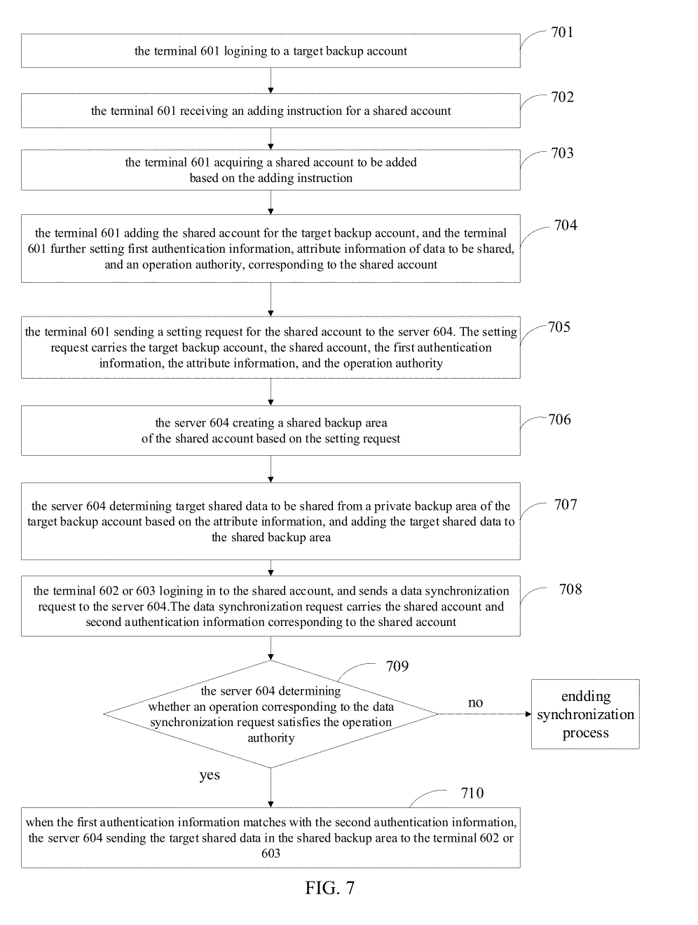

The method of the present disclosure is described in detail below based on the system for synchronizing backup data. As illustrated in FIG. 7, a flow of the method may be as follows.

At block 701, the terminal 601 logins to a target backup account.

In detail, the process of logining to the target backup account by the terminal 601 may include the following operations.

The terminal 601 sends an account login request to the server 604. The account login request carries the target backup account and authentication information of the target backup account.

The server 604 returns a login response message to the terminal 601 based on the account login request.

The terminal 601 logins to the target backup account based on the login response message. In detail, the process of logining to the target backup account may refer to the related description of the second embodiment.

At block 702, the terminal 601 receives an adding instruction for a shared account.

For example, the cloud backup application may provide a shared account adding interface in a main page. The user may add a shared account through the account adding interface. That is, the operation of receiving the adding instruction may include the following operations. The adding instruction triggered by the user through the shared account adding interface may be received. The form of the shared account adding interface may be various, such as an input box and an icon button.

At block 703, the terminal 601 acquires a shared account to be added based on the adding instruction.

The manner of acquiring the shared account may be various. For example, the shared account may be input by the user, or may be randomly generated by the terminal 601.

In an actual application, after the receiving the account adding instruction, the cloud backup application of the terminal may provide a shared account adding page. The shared account adding page has a shared account input interface, such that the user may input the shared account to be added through the shared account input interface.

At block 704, the terminal 601 adds the shared account for the target backup account, and the terminal 601 further sets first authentication information, attribute information of data to be shared, and an operation authority, corresponding to the shared account.

For the setting process of each information, reference may be made to the related description of the second embodiment, and details are not described herein again.

At block 705, the terminal 601 sends a setting request for the shared account to the server 604. The setting request carries the target backup account, the shared account, the first authentication information, the attribute information, and the operation authority.

At block 706, the server 604 creates a shared backup area of the shared account based on the setting request.

In an embodiment, the manner of creating the shared backup area may be various. For example, a storage area may be designated as the shared backup area. That is, the operation of the server 604 creating the shared backup area of the shared account based on the setting request may include the following operations.

The server 604 designates a storage area, based on the setting request.

The server 604 specifies the storage area as the shared backup area of the shared account.

At block 707, the server 604 determines target shared data to be shared from a private backup area of the target backup account based on the attribute information, and adds the target shared data to the shared backup area.

At block 708, the terminal 602 or 603 logins to the shared account, and sends a data synchronization request to the server 604. The data synchronization request carries the shared account and second authentication information of the shared account.

The process of logining to the shared account by the terminal 602 or 603 may include the following operations.

The terminal 602 or 603 acquires the shared account and third authentication information of the shared account.

The terminal 602 or 603 sends a shared account login request to the server 604. The shared account login request carries the shared account and the corresponding third authentication information.

The server 604 matches the first authentication information with the third authentication information. When the matching is successful, the server 604 sends a corresponding shared account login response message to the terminal 602 or 603.

The terminal 602 or 603 logins to the shared account based on the shared account login response message.

At block 709, the server 604 determines whether an operation corresponding to the data synchronization request satisfies the operation authority. When the operation corresponding to the data synchronization request satisfies the operation authority, the operation at block 710 is performed. When the operation corresponding to the data synchronization request does not satisfy the operation authority, the synchronization process ends.

When the operation authority includes: synchronization operation and downloading, it may be determined that the operation corresponding to the data synchronization request satisfies the operation authority.

When the operation authority includes the upload operation authority, the server 604 refuses to process an upload request when the terminal 602 or 603 initiates the upload request.

At block 710, the server 604 matches the first authentication information with the second authentication information. When the first authentication information matches with the second authentication information, the server 604 sends the target shared data in the shared backup area to the terminal 602 or 603.

For example, the server 604 sends the attribute information of the shared data in the shared backup area to the terminal 602 or 603 in response to the data synchronization request. The server 604 receives the synchronization selecting information returned by the terminal 602 or 603 based on the attribute information of the shared data. The corresponding target shared data in the shared backup area is sent to the terminal 602 or 603 based on the synchronization selecting information.

In addition, in an embodiment, after the receiving the setting request, the server 604 may further delete the target shared data in the shared backup area based on the current system time information and the shared time information.

The shared time information may include a shared period. That is, an effective time period of sharing data. For example, the server 604 determines whether the current system time has reached the shared deadline. When the current system time has reached the shared deadline, the server 604 deletes the target shared data in the shared backup area, thereby reducing the stolen risk caused by the long-term existence of the shared data, and saving the storage space on the server.

It may be seen that, in the embodiments of the present disclosure, the terminal 601 sends the setting request to the server 604. The server 604 creates the shared backup area of the shared account based on the setting request. The server 604 adds the target shared data in the private backup area of the target backup account to the shared backup area. The server 604 receives the data synchronization request that is sent by the terminal 602 or 603 and that carries the shared account, and synchronizes the target shared data in the shared backup area in response to the data synchronization request to the terminal 602 or 603. The solution may synchronize the backup data based on the shared account associated with the backup account and the shared backup area of the shared account. When the backup data is synchronized based on the shared account, other synchronous terminals may acquire the backup data in the shared backup area only, and cannot acquire the backup data in the private backup area of the backup account, thereby preventing the backup data from leaking. Therefore, compared with the related art, it may improve the security of the backup data.

The embodiments of the present disclosure may further provide a device for synchronizing backup data. The device may include a receiving unit, a creating unit, an adding unit, and a synchronizing unit.

The receiving unit is configured to receive a setting request for a shared account from a first terminal, the setting request carrying a target backup account, and a shared account corresponding to the target backup account.

The creating unit is configured to create a shared backup area of the shared account based on the setting request.

The adding unit is configured to add target shared data in a private backup area of the target backup account to the shared backup area.

The synchronizing unit is configured to receive a data synchronization request from a second terminal and carrying the shared account, and synchronize the target shared data in the shared backup area to the second terminal in response to the data synchronization request.

In an embodiment, the setting request further carries attribute information of data to be shared corresponding to the shared account.

The adding unit includes a determining sub unit and a copying sub unit.

The determining sub unit is configured to, determine, based on the attribute information, the target shared data in the private backup area of the target backup account.

The copying sub unit is configured to copy the target shared data to the shared backup area.

In an embodiment, the setting request further carries first authentication information of the shared account; the data synchronization request further carries second authentication information of the shared account.

The device includes a matching unit.

The matching unit is configured to, after the data synchronization request is received by the synchronizing unit, and before the target shared data in the shared backup area is synchronized by the synchronizing unit to the second terminal in response to the data synchronization request, match the second authentication information with the first authentication information.

The synchronizing unit is configured to, when the matching is successful, synchronize the target shared data in the shared backup area to the second terminal in response to the data synchronization request.

In an embodiment, the setting request further carries shared time information of the shared account; the device includes a deleting unit.

The deleting unit is configured to, after the setting request is received by the receiving unit, delete the target shared data in the shared backup area based on current system time information and the shared time information.

In an embodiment, the setting request further carries an operation authority of the shared account.

The synchronizing unit is configured to receive the data synchronization request from the second terminal and carrying the shared account, determine whether an operation corresponding to the data synchronization request satisfies the operation authority, and when the operation corresponding to the data synchronization request satisfies the operation authority, synchronize the target shared data in the shared backup area to the second terminal in response to the data synchronization request.

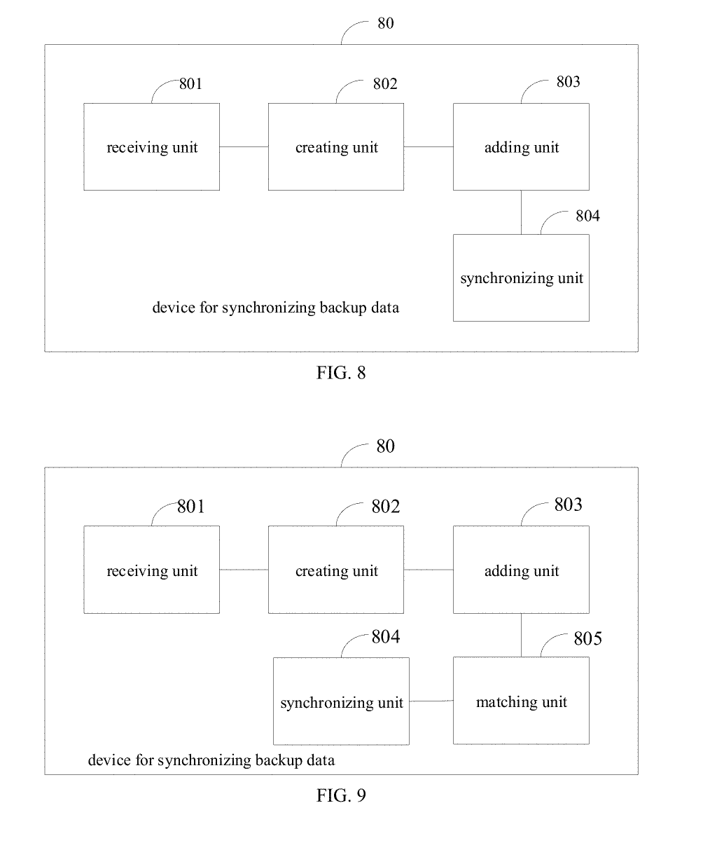

In an embodiment, in order to implement the above method better, the embodiment of the present disclosure further provides a device 80 for synchronizing backup data. As illustrated in FIG. 8, the device 80 includes a receiving unit 801, a creating unit 802, an adding unit 803, and a synchronizing unit 804.

The receiving unit 801 is configured to receive a setting request for a shared account from a first terminal, the setting request carrying a target backup account, and a shared account corresponding to the target backup account.

The creating unit 802 is configured to create a shared backup area of the shared account based on the setting request.

The adding unit 803 is configured to add target shared data in a private backup area of the target backup account to the shared backup area.

The synchronizing unit 804 is configured to receive a data synchronization request from a second terminal and carrying the shared account, and synchronize the target shared data in the shared backup area to the second terminal in response to the data synchronization request.

In an embodiment, to facilitate data synchronization, the setting request further carries attribute information of data to be shared corresponding to the shared account. The adding unit 803 includes a determining sub unit and a copying sub unit.

The determining sub unit is configured to, determine, based on the attribute information, the target shared data in the private backup area of the target backup account.

The copying sub unit is configured to copy the target shared data to the shared backup area.

In an embodiment, to improve data synchronization and account security, the setting request further carries first authentication information of the shared account; the data synchronization request further carries second authentication information of the shared account. As illustrated in FIG. 9, the device 80 further includes a matching unit 805.

The matching unit 805 is configured to, after the data synchronization request is received by the synchronizing unit, and before the target shared data in the shared backup area is synchronized by the synchronizing unit to the second terminal in response to the data synchronization request, match the second authentication information with the first authentication information.

The synchronizing unit 804 is configured to, when the matching is successful, synchronize the target shared data in the shared backup area to the second terminal in response to the data synchronization request.

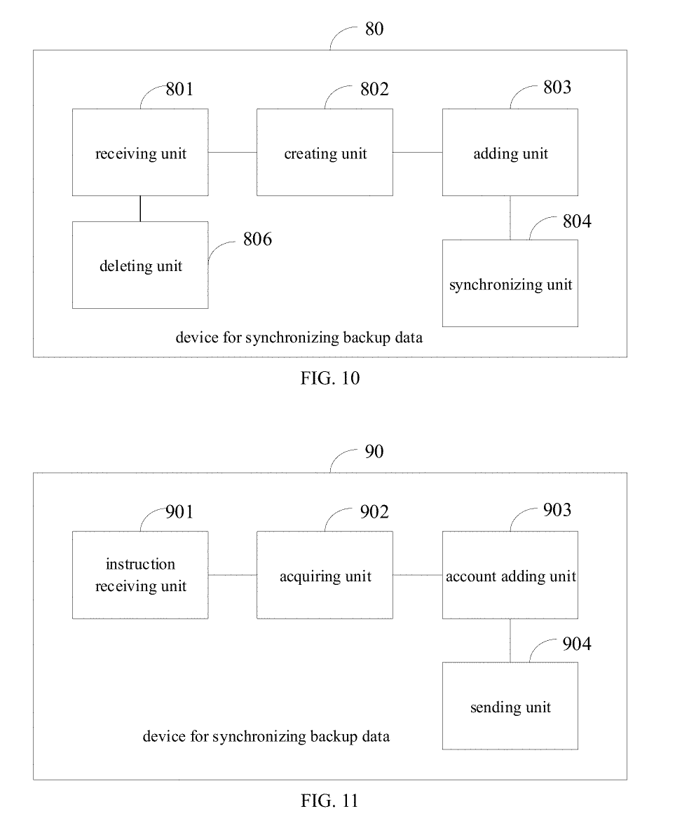

In an embodiment, to save the storage space, the setting request further carries shared time information of the shared account. As illustrated in FIG. 10, the device 80 further includes a deleting unit 806.

The deleting unit 806 is configured to, after the setting request is received by the receiving unit 801, delete the target shared data in the shared backup area based on current system time information and the shared time information.

In an embodiment, to ensure the consistency of data synchronization, the setting request further carries an operation authority of the shared account. The device further includes a determining unit.

The determining unit is configured to, after the synchronizing unit 804 receives the data synchronization request, and before the synchronizing unit 804 synchronize the target shared data in the shared backup area to the second terminal in response to the data synchronization request, determine whether an operation corresponding to the data synchronization request satisfies the operation authority.

The synchronizing unit 804 is configured to, when the operation corresponding to the data synchronization request satisfies the operation authority, synchronize the target shared data in the shared backup area to the second terminal in response to the data synchronization request.

In an implementation, each foregoing unit may be implemented as a separate entity, and may be implemented in any combination, and may be implemented as the same or a plurality of entities. For the implementation of the foregoing, the reference may be made to the foregoing method embodiments, and details are not described herein.

The device may be specifically integrated in a server, such as a cloud server.

In the embodiments of the present disclosure, the receiving unit 804 receives the setting request for the shared account from the first terminal. The setting request carries the target backup account, and the shared account corresponding to the target backup account. The creating unit 802 creates the shared backup area of the shared account based on the setting request. The adding unit 803 adds the target shared data in the private backup area of the target backup account to the shared backup area. The synchronizing unit 804 receive the data synchronization request from a second terminal and carrying the shared account, and synchronize the target shared data in the shared backup area to the second terminal in response to the data synchronization request. The solution may synchronize the backup data based on the shared account associated with the backup account and the shared backup area of the shared account. When the backup data is synchronized based on the shared account, other synchronous terminals may acquire the backup data in the shared backup area only, and cannot acquire the backup data in the private backup area of the backup account, thereby preventing the backup data from leaking. Therefore, compared with the related art, it may improve the security of the backup data.

The embodiments of the present disclosure further provide a device for synchronizing backup data. The device further includes an instruction receiving unit, an acquiring unit, an account adding unit, and a sending unit.

The instruction receiving unit is configured to, after logining to a target backup account, receive an adding instruction for a shared account.

The acquiring unit is configured to acquire a shared account to be added based on the adding instruction.

The account adding unit is configured to add the shared account for the target backup account.

The sending unit is configured to send a setting request for the shared account carrying the target backup account and the shared account to a cloud server, such that the cloud server synchronizes the backup data based on the setting request.

In an embodiment, the device further includes a verifying unit.

The verifying unit is configured to, after the adding instruction is received by the instruction receiving unit, and before the shared account to be added is acquired by the acquiring unit, acquire authentication information input by a user and corresponding to the target backup account, and verify the authentication information input by the user.

The acquiring unit is configured to, and when the verification is passed, acquire the shared account to be added based on the adding instruction.

In an embodiment, the device further includes a setting unit.

The setting unit is configured to, after the shared account is added by the adding unit for the target backup account, and before the shared account setting request is sent by the sending unit to the cloud server, perform at least one of the following operations: setting authentication information of the shared account; setting shared time information of the shared account; setting attribute information of data to be shared corresponding to the shared account; and setting an operation authority of the shared account.

The corresponding shared account setting request further carries at least one of: the authentication information, the shared time information, the attribute information, and the operation authority.

In an embodiment, to implement the above method better, the embodiments of the present disclosure further provide another device 90 for synchronizing backup data. As illustrated in FIG. 11, the device 90 includes an instruction receiving unit 901, an acquiring unit 902, an account adding unit 903, and a sending unit 904.

The instruction receiving unit 901 is configured to, after logining to a target backup account, receive an adding instruction for a shared account.

The acquiring unit 902 is configured to acquire a shared account to be added based on the adding instruction.

The account adding unit 903 is configured to add the shared account for the target backup account.

The sending unit 904 is configured to send a setting request for the shared account carrying the target backup account and the shared account to a cloud server, such that the cloud server synchronizes the backup data based on the setting request.

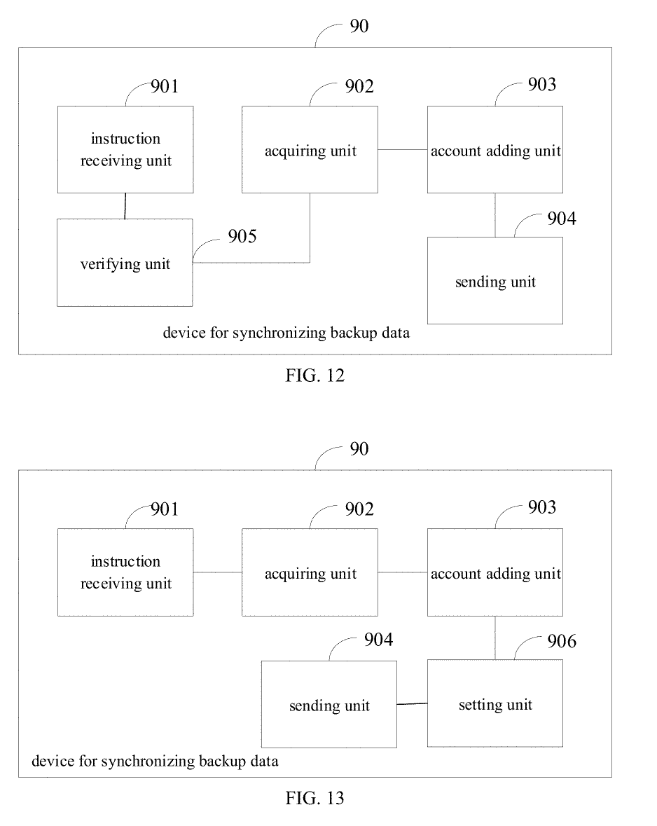

In an embodiment, to ensure the security of data synchronization, as illustrated in FIG. 12, the device 90 of the embodiment may further include a verifying unit 905.

The verifying unit 905 is configured to, after the adding instruction is received by the instruction receiving unit 901, and before the shared account to be added is acquired by the acquiring unit 902, acquire authentication information input by a user and corresponding to the target backup account, and verify the authentication information input by the user.

The acquiring unit 902 is configured to, and when the verification is passed, acquire the shared account to be added based on the adding instruction.

In an embodiment, as illustrated in FIG. 13, the device 90 further includes a setting unit 906.

The setting unit 906 is configured to, after the shared account is added by the adding unit 903 for the target backup account, and before the setting request is sent by the sending unit 904 to the cloud server, perform at least one of the following operations.

Authentication information of the shared account is set.

Shared time information of the shared account is set.

Attribute information of data to be shared corresponding to the shared account is set.

An operation authority of the shared account is set.

The corresponding setting request further carries at least one of: the authentication information, the shared time information, the attribute information, and the operation authority.

In an implementation, each foregoing unit may be implemented as a separate entity, and may be implemented in any combination, and may be implemented as the same or a plurality of entities. For the implementation of the foregoing, the reference may be made to the foregoing method embodiments, and details are not described herein.

The device may be integrated in the terminal, such as a mobile phone, a notebook computer, a tablet computer, and the like.

It may be seen that, in the embodiments of the present disclosure, the instruction receiving unit 901 receives the adding instruction after logining to the target backup account. The acquiring unit 902 acquires the shared account to be added based on the adding instruction. The account adding unit 903 adds the shared account for the target backup account. The sending unit 904 sends the setting request carrying the target backup account and the shared account to the cloud server, such that the cloud server synchronizes the backup data based on the setting request. The solution may synchronize the backup data based on the shared account associated with the backup account and the shared backup area of the shared account. When the backup data is synchronized based on the shared account, other synchronous terminals may acquire the backup data in the shared backup area only, and cannot acquire the backup data in the private backup area of the backup account, thereby preventing the backup data from leaking. Therefore, compared with the related art, it may improve the security of the backup data.

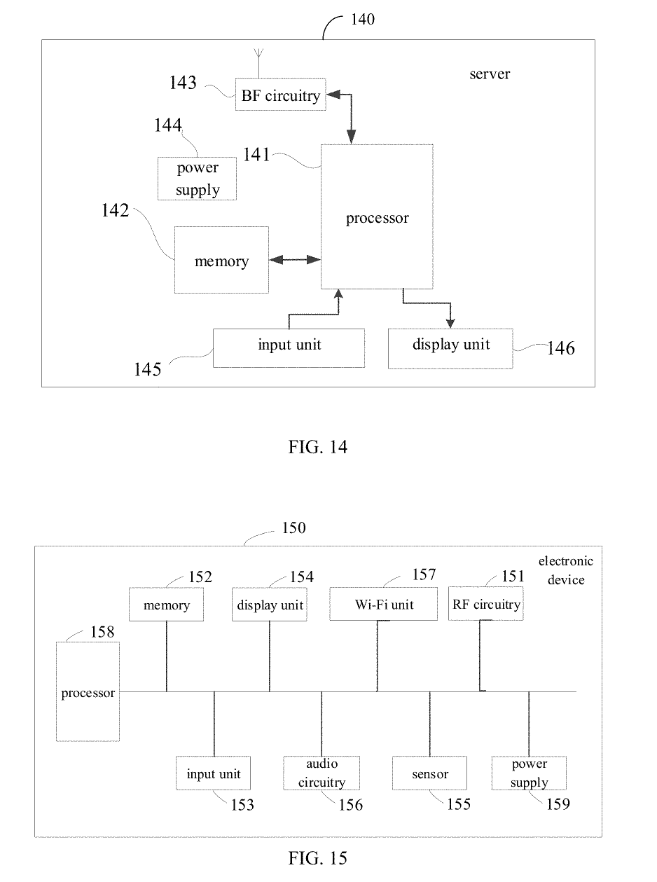

Embodiments of the present disclosure further provide a server. The server includes a processor and a memory. The memory is configured to store a plurality of instructions. The processor is configured to load the instructions stored in the memory to perform the method suitable for the server provided in any of the embodiments of the present disclosure. In an embodiment, the embodiment provides a server. The device of the second embodiment may be integrated in the server. As illustrated in FIG. 14, it is a schematic structural diagram of a server according to an embodiment of the present disclosure.

The server 140 may include a processor 141 having one or more processing cores, a memory 142 having one or more computer readable storage media, a radio frequency (BF) circuitry 143, a power supply 144, an input unit 145, and a display unit 146 and the like. It should be understood by those skilled in the art that the structure of the server illustrated in FIG. 14 does not limit the server. The server may include less or more components than those illustrated in FIG. 9 or combinations thereof, or have a different arrangement of components.

The processor 141 is a control center of the server, which utilizes various interfaces and wires to connect various parts of the server. By running or executing the software program and/or modules stored in the memory 142, and by invoking data stored in the memory 142, the various functions and data processing functions may be executed, thus integrally monitoring the server. In an embodiment, the processor 141 may include one or more processing cores. In an embodiment, the processor 141 may be integrated with a processor or a modem processor. The processor processes the operation system, a user interface and an application. The modem processor processes wireless communication. It may be understood that, the above modem controller may be not integrated in the processor 141.

The memory 142 may be configured to store software programs or modules. The processor 141 is configured to execute various functional applications and data processes by running the software programs and modules stored in the memory 142.

The BF circuitry 143 may be configured for receiving and transmitting signals during the process of transmitting and receiving information. In detail, the BF circuitry 143 receives the signal transmitted by the terminal and hands the data acquisition request to one or more processors 141 for processing. At the same time, the BF circuitry 143 transmits the feedback signal sent by the processor 141 to the terminal.

The server may further include a power supply 144 (such as a battery) for providing powers to various parts. Alternatively, the power supply may be logically connected to a power management system and the processor 141, thereby managing a charging, discharging and power consumption via the power management system. The power supply 144 may also include any one or more of a DC (Direct Voltage) or AC (Alternating Voltage) power source, a recharging system, a power failure detection circuit, a power converter or inverter, a power status indicator, and the like.

The server may further include an input unit 145. The input unit 145 may be configured to receive figures or character information inputted and to generate a keyboard, a mouse, a joystick, an optical or trackball signal input related to a user setup or function control.

The server may further include a display unit 146. The display unit 146 may be configured to display information inputted by the user or various graphical user interfaces of the server, which may include graphics, text, icons, video, and any combination thereof. The display unit 146 may include a display panel. In an embodiment, the display panel may be configured as a liquid crystal display (LCD), an organic light-emitting diode (OLED) and the like.

In embodiments of the present disclosure, the processor 141 in the server loads the executable file corresponding to the process of one or more programs into the memory 142 according to the following instructions, and the processor 141 runs the programs stored in the memory 142 to achieve various functions as follows.

A setting request for a shared account from a first terminal is received. The setting request carries a target backup account, and a shared account corresponding to the target backup account. A shared backup area of the shared account is created based on the setting request. Target shared data in a private backup area of the target backup account is added to the shared backup area. A data synchronization request from a second terminal and carrying the shared account is received, and the target shared data in the shared backup area is synchronized to the second terminal in response to the data synchronization request.

In an embodiment, the setting request further carries attribute information of data to be shared corresponding to the shared account. The adding the target shared data in the private backup area of the target backup account to the shared backup area, includes the following. Based on the attribute information, the target shared data in the private backup area of the target backup account is determined. The target shared data is copied into the shared backup area.

For the foregoing operations, the reference may be made to the foregoing method embodiments, and details are not described herein again.

The embodiments of the present disclosure further provide an electronic device. The electronic device includes a processor and a memory. The memory is configured to store a plurality of instructions. The processor is configured to load the instructions stored in the memory to perform the method suitable to the electronic device or the terminal according to any one of the embodiments of the present disclosure.

In an embodiment, as illustrated in FIG. 15, a terminal 15 is provided and integrated with the device described in the first embodiment. The terminal 15 may include a radio frequency (RF) circuitry 151, a memory 152 having one or more computer readable storage media, an input unit 153, a display unit 154, a sensor 155, an audio circuitry 156, a wireless fidelity (Wi-Fi) unit 157, a processor 158 having one or more processing cores, a power supply 159, and a camera 150. It may be understood by those skilled in the art that, the structures of the terminal illustrated in FIG. 15 do not limit the structures of the terminal. The terminal may include less or more components than those illustrated in FIG. 15 or combinations thereof, or have a different arrangement of components.

The RF circuitry 151 may be configured to receive or transmit messages, or, receive and transmit signals during a call. In detail, after downlink information of the base station is received, it is processed by one or more processors 158; in addition, data related to the uplink is transmitted to the base station. In general, the RF circuitry 151 includes but is not limited to an antenna, at least one amplifier, a tuner, one or more oscillators, a subscriber identity module (SIM), a transceiver, a coupler, a low noise amplifier (LNA), a diplexer and the like. Furthermore, the RF circuitry 151 may be further configured to communicate with other devices via wireless communication and network. The above wireless communication may adopt any one of communication standards or protocols, including but not being limited to global system of mobile communication (GSM), general packet radio service (GPRS), code division multiple access (CDMA), wideband code division multiple access (WCDMA), long term evolution (LTE), e-mail, short messaging service (SMS) and the like.

The memory 152 may be configured to store software programs or modules. The processor 158 is configured to execute various functional applications and data processes by running the software programs and modules stored in the memory 152. The memory 152 may include a program storage region and a data storage region. The program storage region may store an operation system, applications required by at least one function (such as sound playback function, image playback function) and the like. The data storage region may store data (such as audio data, phone book) produced by using the terminal and the like. In addition, the memory 152 may include a high-speed random-access memory and may include a non-volatility memory, such as at least one disk memory, a flash memory, or other volatility solid state memory. Accordingly, the memory 152 may also include a memory controller to provide access to the memory 152 by the processor 158 and the input unit 153.

The input unit 153 may be configured to receive figures or character information inputted and to generate a keyboard, a mouse, a joystick, an optical or trackball signal input related to a user setup or function control. In detail, the input unit 153 may include a touch panel and other input devices. The touch panel (also called as touch screen) may be configured to gather touch operations near or on the touch panel (such as an operation on the touch panel or near the touch panel of the user with a finger, a stylus or other suitable objects or attachments), and drive corresponding connected device according to a preset program. In an embodiment, the touch panel may include a touch detection device and a touch controller. The touch detection device detects an orientation of the user's touch, detects a signal caused by the touch operation and sends the signal to the touch controller. The touch controller receives the touch information on the touch detection device, converts the touch information to touch point coordinates, and sends the touch point coordinates to the processor 158. Furthermore, the touch controller may receive and execute a command sent from the processor 158. The touch panel may be implemented as resistance typed, capacitive typed, infrared typed and surface acoustic wave typed. In addition to the touch panel, the input unit 153 may further include other input devices. In detail, the other input devices may include but not limited to one or more of a physical keyboard, a functional key (such as a volume control key, a switch key and the like), a trackball, a mouse, a joystick, a fingerprint recognition module, etc.

The display unit 154 may be configured to display information inputted by the user or various graphical user interfaces of the terminal, which may include graphics, text, icons, video, and any combination thereof. The display unit 154 may include a display panel. In an embodiment, the display panel may be configured as a liquid crystal display (LCD), an organic light-emitting diode (OLED) and the like. In an embodiment, the touch panel may cover the display panel. When the touch panel detects the touch operation on the touch panel or near the touch panel, the touch operation is transmitted to the processor 158 to determine a type of the touch event. Thereafter, the processor 158 provides a corresponding visual output on the display panel according to the type of the touch event. Although the touch panel and the display panel are two separate components to realize an input and output function illustrated in FIG. 15, in certain embodiments, the touch panel and the display panel may be integrated to realize the input and output function,

The terminal may further include at least one sensor 155, such as an optical sensor, a motion sensor and other sensors. In detail, the optical sensor may include a surrounding light sensor and a proximity sensor. The surrounding light sensor may adjust a luminance of the display panel according to surrounding lights. The proximity sensor may close the display panel and/or backlight when the terminal moves near ears of the user. As the motion sensor, an acceleration sensor may be configured to measure acceleration values in various directions (generally in three axes), measure a value and a direction of gravity when the terminal is static, and identify the phone gesture applications (such as horizontal and vertical screen switching, related games, magnetometer attitude calibration), identify, based on vibration, related functions (such as pedometer, percussion), and the like. Furthermore, the terminal may be configured with a gyroscope, a barometer, a humidity meter, a thermometer, an infrared sensor, which are not elaborated in embodiments of the present disclosure.

The audio circuitry 156 may provide an audio interface between the user and the phone through a loudspeaker and a microphone. The audio circuitry 156 may transmit electrical signals converted from received audio data to the loudspeaker. The loudspeaker converts the electrical signals to sound signals and outputs the sound signals. In another aspect, the microphone may convert collected sound singles to electrical signals. The audio circuitry 156 receives and converts the electrical signals to audio data and outputs the audio data to the processor 158 to be processed. The audio data processed by the processor 158 may be transmitted to for example another phone via the RF circuitry 151 or may be stored in the memory 152 for subsequently processing. The audio circuitry 156 may also include an earbud jack to provide communication of the peripheral earphones with the terminal.

Wi-Fi is a short distance wireless communication technology. The terminal may help the user to receive or send an e-mail, search webpages, access stream medium via the Wi-Fi unit 157. The Wi-Fi unit 157 provides a wireless broadband Internet access. Although the Wi-Fi unit 157 is illustrated in FIG. 8, it may be understood that, the Wi-Fi unit 157 is not necessary for the phone, thus it may be omitted based on demands without changing the scope of the present disclosure.

The processor 158 is a control center of the terminal, which utilizes various interfaces and wires to connect various parts of the terminal. By running or executing the software program and/or modules stored in the memory 152, and by invoking data stored in the memory 152, the various functions and data processing functions may be executed, thus integrally monitoring the terminal. In an embodiment, the processor 158 may include one or more processing cores. In an embodiment, the processor 158 may be integrated with an application processor or a modem processor. The application processor processes the operation system, a user interface and an application. The modem processor processes wireless communication. It may be understood that, the above modem controller may be not integrated in the processor 158.

The terminal may further include a power supply 159 (such as a battery) for providing powers to various parts of the terminal. Alternatively, the power supply may be logically connected to a power management system and the processor 158, thereby managing a charging, discharging and power consumption via the power management system. The power supply 159 may also include any one or more of a DC (Direct Voltage) or AC (Alternating Voltage) power source, a recharging system, a power failure detection circuit, a power converter or inverter, a power status indicator, and the like.

The terminal further includes a camera 150 having a capturing function (such as a front camera, a rear camera, etc.). Alternatively, the camera may be logically coupled the processor 158 through a video processing system, a camera driver, etc., thereby implementing functions such as photographing and imaging through the video processing system and the camera driver.

Although not illustrated, the terminal may further include a Bluetooth module and the like, which are not elaborated herein.

In embodiments of the present disclosure, the processor 158 in the terminal loads the executable file corresponding to the process of one or more programs into the memory 152 according to the following instructions, and the processor 158 runs the programs stored in the memory 152 to achieve various functions as follows.

After logining to a target backup account, an adding instruction for a shared account is received. A shared account to be added is acquired based on the adding instruction. The shared account is added for the target backup account. A setting request for the shared account is sent to a cloud server, the setting request carrying the target backup account and the shared account, such that the cloud server synchronizes the backup data based on the setting request.

In an embodiment, after the receiving the adding instruction, and before the acquiring the shared account to be added, the function may further include the following. Authentication information input by a user and corresponding to the target backup account is acquired. The authentication information input by the user is verified. When the verification is passed, the acquiring the shared account to be added based on the adding instruction is performed.

In an embodiment, after the adding the shared account for the target backup account, and before the sending the setting request to the cloud server, the function further include at least one of the following. Authentication information of the shared account is set. Shared time information of the shared account is set. Attribute information of data to be shared corresponding to the shared account is set. An operation authority of the shared account is set.

The corresponding setting request further carries at least one of: authentication information, shared time information, attribute information, and an operation authority.

For the foregoing operations, the reference may be made to the foregoing method embodiments, and details are not described herein again.

Those skilled in the art may understand that all or part of the operations of the foregoing embodiments may be implemented by a program to instruct related hardware. The program may be stored in a computer readable storage medium, and the storage medium may include: Read Only Memory (ROM), Random Access Memory (RAM), disk or optical disk.

The method for synchronizing backup data, the device for synchronizing backup data, the storage medium, the electronic device, and the server provided by the embodiments of the present disclosure are described in detail. Specific examples are used herein to describe the principles and implementation manners of the present disclosure. The description of the above embodiments is merely used to help understand the method and key idea of the present disclosure. Meanwhile, those skilled in the art may make modifications to the detailed description and application scopes according to ideas of the present disclosure. In view of the above descriptions, the specification should not be construed as limiting the present disclosure.

What is claimed is:

1. A method for synchronizing backup data, comprising:
logining to a target backup account;
receiving an adding instruction for a shared account;
acquiring the shared account based on the adding instruction;
adding the shared account for the target backup account; and
sending, to a cloud server, a setting request for the shared account, the setting request carrying the target backup account and the shared account.

2. The method of claim 1, further comprising:
acquiring authentication information of the target backup account;
sending, to the cloud server, the authentication information;
receiving, from the cloud server, a verification result; and
acquiring the shared account based on the adding instruction when the verification result indicates that the verification is passed.

3. The method of claim 1, further comprising at least one of:
setting authentication information of the shared account;
setting shared time information of the shared account;
setting attribute information of data to be shared corresponding to the shared account; and
setting an operation authority of the shared account.

4. The method of claim 3, wherein the setting request carries at least one of: the authentication information, the shared time information, the attribute information, and the operation authority.

5. The method of claim 1, further comprising:
providing an adding interface for the shared account; and
acquiring the adding instruction based on an input of a user on the adding interface.

6. The method of claim 5, further comprising:
providing an input interface for the shared account based on the adding instruction; and
receiving the shared account input by the user on the input interface.

7. The method of claim 1, wherein adding the shared account for the target backup account comprises:
binding the shared account with the target backup account.

8. The method of claim 3, further comprising:
providing a setting interface for the shared account; and
receiving information input by a user on the setting interface, wherein the information comprising at least one of: the authentication information, the shared time information, the attribute information, and the operation authority.

9. A method for synchronizing backup data in a server, comprising:
receiving, from a first terminal, a setting request for a shared account, the setting request carrying a target backup account and a shared account for the target backup account;
creating a shared backup area of the shared account based on the setting request;
adding target shared data in a private backup area of the target backup account to the shared backup area;
receiving, from a second terminal, a data synchronization request carrying the shared account; and
synchronizing the target shared data in the shared backup area to the second terminal in response to the data synchronization request.

10. The method of claim 9, wherein the setting request further carries at least one of: attribute information of data to be shared corresponding to the shared account, first authentication information of the shared account, shared time information of the shared account, and an operation authority of the shared account.

11. The method of claim 10, wherein the data synchronization request carries second authentication information of the shared account, the method further comprises:
determining whether the second authentication information is matched with the first authentication information; and
synchronizing the target shared data in the shared backup area to the second terminal in response to the data synchronization request when the second authentication information is matched with the first authentication information.

12. The method of claim 10, further comprising:
deleting the target shared data in the shared backup area based on current system time information and the shared time information.

13. The method of claim 10, further comprising:
determining whether an operation corresponding to the data synchronization request satisfies the operation authority;
synchronizing the target shared data in the shared backup area to the second terminal in response to the data synchronization request when the operation satisfies the operation authority.

14. The method of claim 10, further comprising:
determining, based on the attribute information, the target shared data in the private backup area corresponding to the target backup account; and
copying the target shared data into the shared backup area.

15. A non-transient computer readable storage medium, applicable to a terminal, and having stored a plurality of instructions thereon, the plurality of instructions being adaptable to be loaded by a processor to perform a method comprising:
logining to a target backup account;
receiving an adding instruction for a shared account;
acquiring the shared account based on the adding instruction;
adding the shared account for the target backup account; and
sending, to a cloud server, a setting request for the shared account, the setting request carrying the target backup account and the shared account.

16. The storage medium of claim 15, wherein the method further comprises:
acquiring authentication information of the target backup account;
sending, to the cloud server, the authentication information;
receiving, from the cloud server, a verification result; and
acquiring the shared account based on the adding instruction when the verification result indicates that the verification is passed.

17. The storage medium of claim 15, further comprising at least one of:
setting authentication information of the shared account;
setting shared time information of the shared account;
setting attribute information of data to be shared corresponding to the shared account; and
setting an operation authority of the shared account.

18. The storage medium of claim 17, wherein the setting request carries at least one of: the authentication information, the shared time information, the attribute information, and the operation authority.

19. The storage medium of claim 15, wherein the method further comprises:
providing an adding interface for the shared account; and
acquiring the adding instruction based on an input of a user on the adding interface.

20. The storage medium of claim 15, wherein adding the shared account for the target backup account comprises:
binding the shared account with the target backup account.
